(19) United States
(12) Patent Application Publication
(10) Pub. No.: US 2026/0257549 A1
(43) Pub. Date: Sep. 3, 2026

(54) UNDERBODY PROTECTION FOR MOTOR VEHICLES, BATTERY HOUSING FOR A TRACTION BATTERY, TRACTION BATTERY FOR MOTOR VEHICLES AND MOTOR VEHICLE WITH UNDERBODY PROTECTION

(71) Applicant: KAUTEX TEXTRON GMBH & CO. KG, Bonn (DE)

(72) Inventor: Daniel HEIDRICH, Rommerskirchen (DE)

(73) Assignee: KAUTEX TEXTRON GMBH & CO. KG, Bonn (DE)

(21) Appl. No.: 19/159,898

(22) PCT Filed: Feb. 21, 2024
(86) PCT No.: PCT/EP2024/054373

§ 371 Date: Aug. 26, 2025

(30) Foreign Application Priority Data
Feb. 27, 2023 (DE) 10 2023 104 735.3

(51) Int. Cl. B60K 1/04; B62D 25/20; B62D 29/00; H01M 50/204; H01M 50/242; H01M 50/249

(52) U.S. Cl. CPC B60K 1/04; B62D 25/2072; B62D 29/00; H01M 50/204; H01M 50/242; H01M 50/249; B60K 2001/0438; H01M 2220/20

(57) ABSTRACT

The present invention discloses an underbody protection (1) for a motor vehicle, comprising at least one base component (10), at least one protective element (20) and at least two ribs (30). The at least two ribs (30) are sandwiched between the protective element (20) and the base component (10), a plurality of cavities (40) are formed between the protective element (20) and an underside (12) of the base component (10), which are at least partially delimited by the ribs (30), and the protective element (20) is connected to the base component (10).

The present invention further discloses a battery housing (90) with an underbody protection (1) according to the invention, a traction battery (80) with a battery housing (90) according to the invention and a motor vehicle with a traction battery (80) according to the invention.

The present invention relates to an underbody protection for motor vehicles, in particular for electric motor vehicles. Furthermore, the present invention relates to a battery housing for a traction battery. Furthermore, the present invention relates to a traction battery for a motor vehicle. Finally, the present invention relates to a motor vehicle, in particular an electric motor vehicle with an underbody protection.

Various types of underbody protection systems are known from the prior art. Mainly heavy steel plates or welded steel assemblies are used as underbody protection to absorb the high intrusion force and impact energy when vehicles dynamically hit obstacles. Such underbody protection systems increase the overall weight of the vehicle. In addition, underbody protection made of steel has an increased risk of corrosion. There are also problems with underbody protection systems of this type with regard to distortion, especially if this type of underbody protection system is attached to a plastic component of the vehicle. This is be-cause a corresponding plastic component generally has a different coefficient of expansion when exposed to heat than the underbody protection system, so that corresponding underbody protection systems warp when the temperature changes.

The problem underlying the invention is to provide an underbody protection system that is highly rigid and energy-absorbing while at the same time being lightweight and, in addition, has reduced warpage compared to underbody protection systems known from the prior art.

The problem underlying the present invention is solved by an underbody protection having the features of claim 1. Advantageous embodiments of the underbody protection are described in the claims dependent on claim 1.

More specifically, the problem underlying the present invention is solved by an underbody protection for a motor vehicle, which has at least one base component, at least one protective element and at least two ribs. In the underbody protection according to the invention, the at least two ribs are arranged in a sandwich-like manner between the protective element and the base component, wherein a plurality of cavities are formed between the protective element and an underside of the base component, which cavities are at least partially defined by the ribs, and wherein the protective element is connected to the base component.

The underbody protection according to the invention has the advantage that the protective effect of the underbody protection is increased against mechanical impact, for example by a collision. The protective element can deform in the cavities of the underbody protection in the event of a mechanical impact, for example due to an impact caused by the dynamic contact of a motor vehicle with a surface, and convert the energy generated by the impact into mechanical deformation energy. The base component is protected from deformation due to the deformation of the protective element in the cavities of the underbody protection, so that components of the motor vehicle located above the protective element are effectively protected. As a result, the underbody protection has an increased protective effect against mechanical impact.

Furthermore, due to its layer structure, the underbody protection according to the invention has the advantage that it has a reduced tendency to warp when exposed to heat.

Furthermore, the underbody protection according to the invention has a weight advantage over the underbody protection systems known from the prior art.

The underbody protection is designed for a motor vehicle, in particular for an electrically powered vehicle (electric motor vehicle).

The base component can have a plastic material or consist of a plastic material. In this case, the base component can also be referred to as a plastic component. Furthermore, the base component can have a metal or consist of a metal.

The underside of the base component is the side facing away from the component to which the underbody protection is attached (e.g. traction battery). For example, if the base component is designed as a battery housing shell, the underside of the base component is the side that faces away from a receiving volume of the base component or the battery housing shell.

The basic component, which is designed as a plastic component, can have a thermoplastic and/or thermosetting plastic.

The base component, which is designed as a plastic component, can be designed as a fiber-reinforced plastic component, at least in sections. This can improve the bending stiffness of the underbody protection.

The base component, which is designed as a plastic component, can have short fibers and/or long fibers and/or continuous fibers. This can further improve the bending stiffness of the underbody protection.

The fibers of the base component, which is designed as a plastic component, can be in the form of glass fibers and/or carbon fibers and/or aramid fibers.

The basic component, which is designed as a plastic component, can be manufactured using compression molding processes such as long-fiber thermoplastic extrusion, glass mat thermoplastic compression molding or injection molding.

The base component is preferably shell-shaped. preferably, a receiving space of the shell-shaped base component faces away from the ribs.

The protective element can also be referred to as a protective plate. The protective element can be designed as an essentially flat component.

The protective element preferably has a thickness extension in a range between 0.5 mm (millimeters) and 5 mm, further preferably in a range between 1 mm and 4 mm, further preferably in a range between 1.5 mm and 3 mm.

Preferably, the underbody protection has a plurality of protective elements. Further preferably, a protective element is arranged in a respective receiving area of the base component, which is bounded by at least one, preferably at least two ribs, further preferably at least three ribs and again further preferably by four ribs.

The underbody protection can have a plurality of ribs. A first subset of the ribs can be aligned parallel to one another, for example, and a second subset of the ribs can be aligned in a crossed manner to the first subset of the ribs.

The ribs can have a wall thickness in the range from 1 mm to 5 mm, preferably in the range from 2 mm to 4 mm.

The ribs preferably have a height extension in a range between 4 mm and 30 mm, more preferably in a range between 8 mm and 15 mm.

The ribs can extend in a regular pattern between the protective element and the base component. This improves the bending stiffness of the underbody protection.

The majority of the cavities can have a width and/or a length in the range from 30 mm to 100 mm, preferably in the range from 40 mm to 60 mm.

Preferably, the protective element is detachable from the base component so that, if the protective element is damaged, it can be removed from the base component and replaced with a new protective element.

The protective element can preferably be connected to the base component by a force-fit and/or form-fit and/or material-fit.

The protective element can be connected to the base component by means of connecting elements. Connecting elements can be designed as screws, rivets or other connecting elements. For example, a cavity with an undercut or a through hole can be formed in the protective element. The material of the base component can extend into the cavity so that a rivet is formed in this way. Furthermore, the material of the base component can extend through a through hole, the wall of which is preferably chamfered, so that a rivet is formed in this way. Furthermore, for example, the protective element can be glued to the base component. The protective element can also be welded to the base component, for example.

The underbody protection can have a number of protective elements. The respective protective elements are preferably arranged next to each other. This increases the flexibility of the underbody protection.

Preferably, the underbody protection is designed in such a way that the protective element has at least one plastic layer and at least one protective layer that is connected to the plastic layer.

The appropriately designed underbody protection is lightweight, but still offers a high level of protection against mechanical impacts, for example when a motor vehicle hits the ground dynamically.

The plastic layer can be made of thermoplastic material, preferably polypropylene or polyamide. Alternatively, the plastic layer can be made of thermosetting plastic.

The plastic layer can be designed as a fiber-reinforced plastic layer, at least in sections. This can improve the flexural rigidity of the underbody protection.

The plastic layer can have long fibers and/or continuous fibers. This can further improve the bending stiffness of the underbody protection.

The fibers of the plastic layer can be in the form of glass fibers and/or carbon fibers and/or aramid fibers.

The protective layer can be designed as an Organosheet, for example. Organosheets are semi-finished fiber-matrix products. These consist of a fiber fabric or a fiber scrim embedded in a thermoplastic matrix. This can improve hot formability and thus shorten production times. In addition, the bending stiffness of the underbody protection can be improved.

The protective layer can also be designed as a metal layer, for example. For example, the metal layer can be designed as a steel layer or steel plate.

The protective element can be produced in a simplified manner, in particular by injection molding, thermoforming and/or by means of compression molding processes such as long-fiber thermoplastic extrusion, glass mat thermoplastic compression molding or injection molding.

Furthermore, the underbody protection is preferably designed in such a way that the at least one protective layer is arranged on an outer side of the protective element facing away from the ribs.

The correspondingly designed underbody protection has even bet ter stability.

Furthermore, the underbody protection is preferably designed in such a way that the at least one protective layer is arranged on an inner side of the protective element facing the ribs.

The correspondingly designed underbody protection has improved long-term stability, as the protective layer is protected against environmental influences (e.g. moisture, damage caused by sand, stones, etc. whirled up while driving).

Further preferably, the underbody protection is designed such that the protective element has two protective layers and a plastic layer, which is connected to the two protective layers, the plastic layer being arranged in a sandwich-like manner between a first protective layer, which is arranged on an outer side of the protective element facing away from the ribs, and a second protective layer, which is arranged on an inner side of the protective element facing the ribs.

The correspondingly designed underbody protection has further improved stability and durability.

Furthermore, the underbody protection is preferably designed in such a way that the protective layer arranged on the inside facing the ribs has a plurality of through openings through which the material of the plastic layer forming the ribs protrudes.

The correspondingly designed underbody protection has improved stability and is also particularly easy to manufacture. This is because the position of the protective layer or second protective layer arranged on the inside facing the ribs is fixed by the fact that the ribs protrude through the through openings. The ribs can be formed, for example, by pressing the material of the plastic layer through the through openings of the protective layer.

Preferably, the underbody protection is designed in such a way that the protective element is connected to the base component by means of a plurality of screws, and at least some of the screws are each screwed into a rib.

The correspondingly designed underbody protection has great stability and is easy to manufacture. This is because by screwing at least some of the screws into one rib at a time, these screws and therefore also the protective element are particularly firmly connected to the base component. Furthermore, when screwing screws into one rib at a time, for example, no fastening nut is required to secure a screw to the base component. This simplifies the manufacture of the underbody protection.

The screws are preferably designed as thread-forming screws that form a thread in the base component when screwed into it.

Preferably, at least some of the screws are screwed into a crossing area of two ribs that cross each other. The correspondingly designed underbody protection has further improved stability.

Preferably, the protective element is connected to the base component by means of ten to eighty screws.

Preferably, the underbody protection is designed in such a way that at least some of the ribs are formed monolithically with the base component.

The correspondingly designed underbody protection is easy to manufacture, as the basic component, including the ribs formed monolithically with it, can be produced simply by means of pressing processes such as long-fiber thermoplastic extrusion, glass mat thermoplastic compression molding or, for example, injection molding.

The feature according to which at least a part of the ribs is formed monolithically with the base component can also be expressed in such a way that a subset of the ribs is formed monolithically with the base component.

The majority of the ribs, preferably all ribs, can be monolithically connected to the base component. Monolithically connected are two components that are made from one continuous piece. In particular, monolithically connected components are connected to each other without joints.

Preferably, the at least one protective element is in direct contact with the ribs.

Preferably, the underbody protection is designed in such a way that at least some of the ribs are formed monolithically with the protective element.

The correspondingly designed underbody protection is easy to manufacture, as the at least one protective element, including the ribs formed monolithically with it, can simply be produced together in a single manufacturing step.

The feature according to which at least a part of the ribs is formed monolithically with the protective element can also be expressed in such a way that a subset of the ribs is formed monolithically with the protective element.

Preferably, the base component is in direct contact with at least some of the ribs and preferably with all ribs.

Preferably, the underbody protection is designed in such a way that the at least one protective element has at least one metal plate and/or at least one plastic element and/or at least one Organosheet.

If the underbody protection has more than one protective element, one protective element can be designed as a metal plate and another protective element as an organic sheet or a plastic element.

If the protective element is designed as a metal plate, the metal plate can be made of aluminum or steel, for example.

Organosheets are semi-finished fiber-matrix products. These consist of a fiber fabric or a fiber scrim embedded in a thermo-plastic matrix. This can improve hot formability and thus shorten production times. In addition, the bending stiffness of the underbody protection can be improved.

The at least one protective element can be made of the same plastic as the base component. This allows the protective element to be better connected to the base component, in particular to be welded better.

If the protective element is designed as a plastic element, it is preferably made of a thermoplastic and/or thermosetting plastic.

If the protective element is designed as a plastic element, it can be designed as a fiber-reinforced plastic element, at least in sections. This can improve the flexural rigidity of the underbody protection.

If the protective element is designed as a plastic element, it can have short fibers and/or long fibers and/or continuous fibers. This can further improve the bending stiffness of the underbody protection.

The fibers of the plastic element can be in the form of glass fibers and/or carbon fibers and/or aramid fibers.

The plastic element can be manufactured using compression molding processes such as long-fiber thermoplastic extrusion, glass mat thermoplastic compression molding or injection molding.

Preferably, the underbody protection is designed in such a way that the underbody protection has a connecting flange arranged on the edge.

Preferably, an outer lateral boundary of the protective element closes in an area of the connecting flange in such a way that the base component covers a cut edge of the protective element. This results in improved side crash properties.

If the protective element has a metal or is made of a metal, then the cut edge of the protective element is covered by the plastic for corrosion protection reasons. Even better side crash properties are achieved if the rigid part of the underbody protection (e.g. a protective element) is flush with a battery housing, for example.

The connecting flange is preferably designed as part of the base component. This makes it easier to manufacture the base component. It also increases the flexural rigidity of the base component.

The connecting flange can extend away from the edge of the base component, in particular in the direction of the width extension and/or the longitudinal extension of the base component.

The connecting flange can have an extension in the direction of the width extension and/or the longitudinal extension of the base component in a range from 8 mm to 40 mm, preferably in a range from 10 mm to 18 mm. This allows the underbody protection to be connected to a motor vehicle in an improved manner.

The connecting flange can have a joining surface. The joining surface can be designed to establish a connection with a motor vehicle or a motor vehicle component, such as a traction battery. The connection to the motor vehicle can be a material connection.

Alternatively or additionally, a mechanical connection can be established by means of connecting elements. Connecting elements can be designed as screws, rivets or other mechanical connecting elements.

The connecting flange can be designed as part of the boundary edge.

The connecting flange can be designed as a connecting flange running around the base component.

Preferably, the protective element is connected to the base component by means of a plurality of screws that are screwed into the connecting flange.

Preferably, a sealant is arranged between the protective element and the base component, which can be a one-component or two-component polyurethane adhesive or a silicone-based adhesive or an adhesive based on silane-modified polymers, for example.

Preferably, an adhesive tape and/or a foam tape and/or a transfer tape, in each case preferably acrylic-based, is arranged between the protective element and the base component.

Preferably, the underbody protection is designed in such a way that a first connecting surface of the protective element is connected to the base component by a material bond.

A material bond connection can be achieved, for example, by welding and/or gluing the base component to the first connecting surface of the protective element.

Preferably, a first adhesion promoter layer is applied to the first connecting surface of the protective element.

The adhesion promoter layer can achieve an improved connection, in particular an improved material bond.

The adhesion promoter layer can be designed as a heat-activated adhesive layer, preferably in the form of a film, a lacquer and/or a powder coating. The powder coating can be thermoplastic or thermosetting. This can achieve an even better material bond between the support structure and the first protective element and the second protective element.

The adhesion promoter layer can have a layer thickness in the range from 0.02 mm to 3 mm, preferably in the range from 0.03 mm to 1 mm, more preferably in the range from 0.05 mm to 0.3 mm.

Preferably, the first connecting surface of the protective element is welded to the base component.

Further preferably, the first connecting surface of the protective element is microstructured. The micro-surface structure of the first connecting surface is produced, for example, by means of a laser micro-structuring process and/or by means of sand-blasting or corundum blasting and/or by means of an etching process.

Preferably, the underbody protection is designed in such a way that at least some of the cavities are filled with a foam material.

The foam material can be in the form of polyurethane foam. The foam material can be in the form of expanded polypropylene or EPP foam.

Preferably, the foam material has a density in a range between 60 g/l and 180 g/l, preferably in a range between 100 g/l and 150 g/l.

Furthermore, the underbody protection is preferably designed in such a way that the protective element is connected to the base component by means of the foam material.

The corresponding underbody protection has a simple structure and is easy to manufacture, as fewer steps are required to produce it.

For example, the base component can have a connecting surface made of polypropylene. Furthermore, the protective element can also have a connecting surface made of polypropylene. The foam material can be formed as EPP foam as described above. The connecting surface of the base component can be materially bonded to the EPP foam, and the connecting surface of the protective element can be materially bonded to the EPP foam, so that the protective element is connected to the base component by means of the foam material.

Preferably, the underbody protection is designed in such a way that the base component is shell-shaped and at least partially delimits a receiving volume which is designed to receive battery cells and/or battery modules.

The correspondingly designed underbody protection has the advantage that the base component combines several functions, namely the function of holding battery cells and/or battery modules and the function of protecting the battery cells and/or battery modules from damage by placing a motor vehicle with a traction battery, which has the described underbody protection, on a surface.

The problem underlying the present invention is further solved by a battery housing for a traction battery, wherein the battery housing has an underbody protection according to one of the embodiments described above, wherein a battery housing shell of the battery housing is formed as a base component of the underbody protection.

The battery housing according to the invention has the advantage that the protective effect of the battery housing is increased against mechanical impact, for example by a collision. The protective element of the underbody protection of the battery housing can deform in the cavities of the underbody protection of the battery housing in the event of a mechanical impact, for example due to a dynamic impact on a surface, and convert the energy generated by the impact into mechanical deformation energy. This gives the battery housing increased protection against mechanical impact.

Furthermore, due to the layered structure of the battery housing shell, the battery housing according to the invention has the advantage that the battery housing shell has a reduced tendency to warp when heat is applied.

Furthermore, the battery housing according to the invention has a weight advantage over the battery housings known from the prior art.

The problem underlying the present invention is further solved by a traction battery for a motor vehicle, wherein the traction battery comprises at least one battery cell and/or at least one battery module and a battery housing as described above, wherein the at least one battery cell and/or the at least one battery module is/are arranged in the battery housing.

A traction battery designed in this way has the advantage that a battery cell arranged in the battery housing and/or a battery module arranged in the battery housing is better protected against direct mechanical impact in the event of a vertical impact on the traction battery due to the improved energy ab-sorption capabilities of the battery housing.

The problem underlying the present invention is further solved by a motor vehicle, in particular an electric motor vehicle, having an underbody protection which is formed according to one of the embodiments described above and which is attached to an underbody of the motor vehicle, in particular to a traction battery of the motor vehicle.

Further advantages, details and features of the invention are shown in the following embodiments. These show in detail:

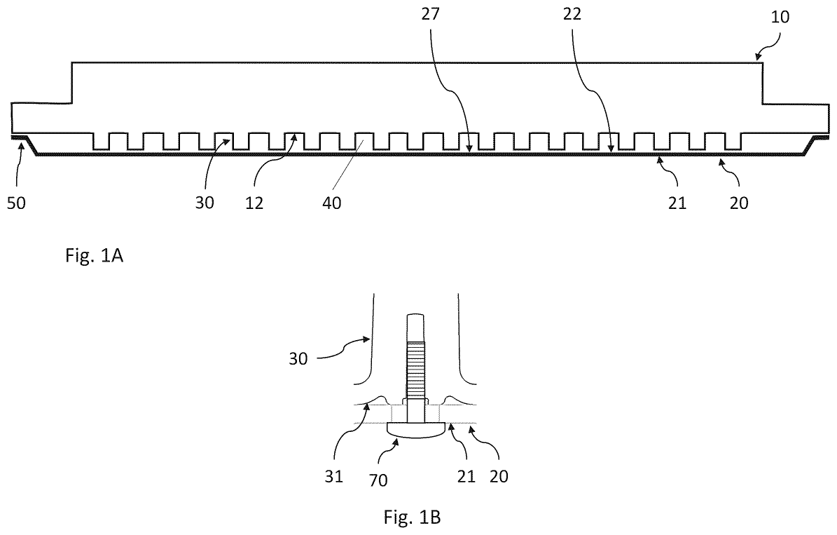

FIG. 1A: a schematic sectional view of an underbody protection according to the invention according to a first embodiment ;

FIG. 1B: a detailed view of a connection area between a protective element and a base component of the underbody protection shown in FIG. 1A;

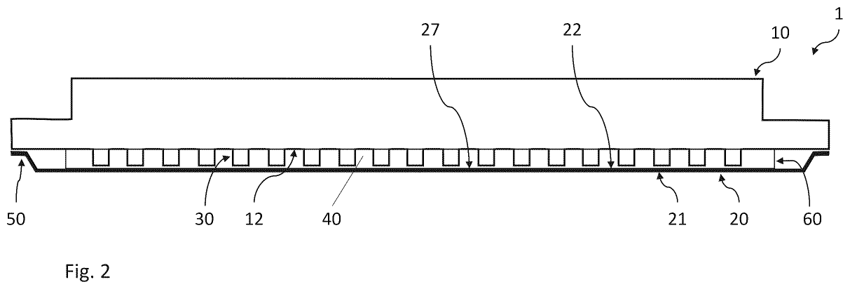

FIG. 2: a schematic sectional view of an underbody protection according to the invention according to a second embodiment;

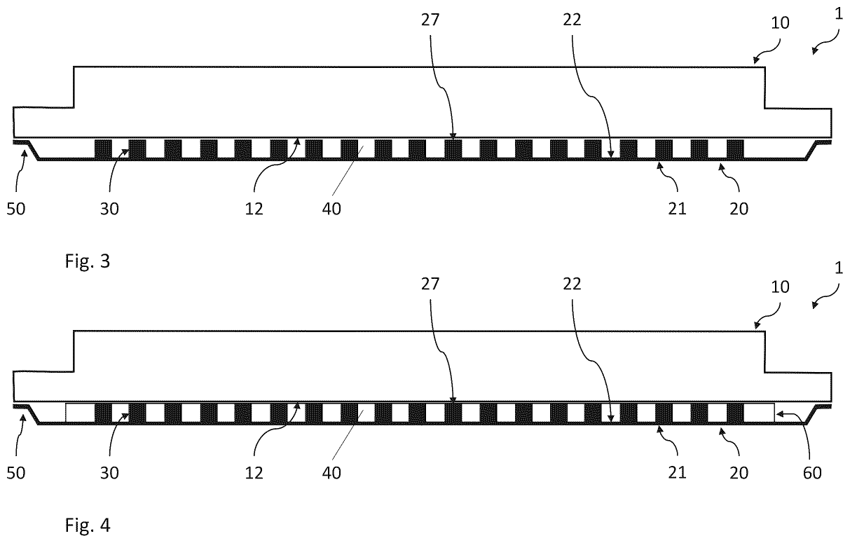

FIG. 3: a schematic sectional view of an underbody protection according to the invention according to a third embodiment ;

FIG. 4: a schematic sectional view of an underbody protection according to the invention according to a fourth embodiment ;

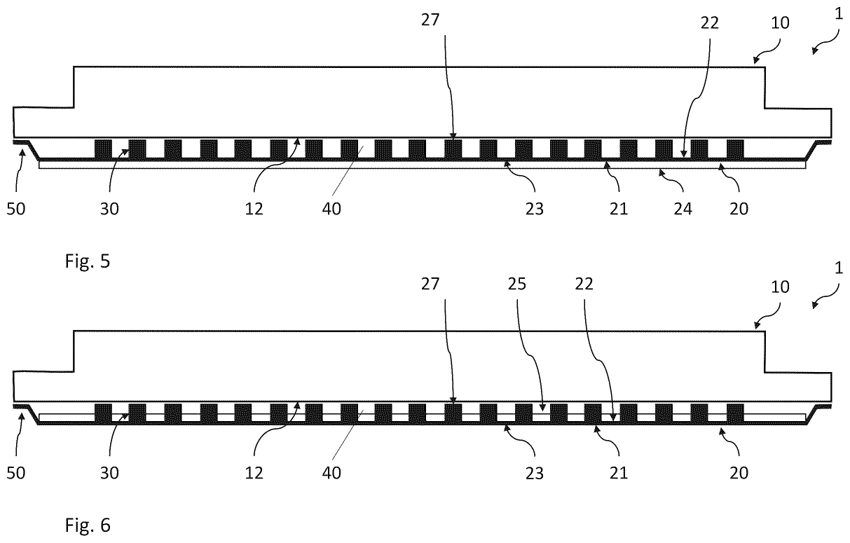

FIG. 5: a schematic sectional view of an underbody protection according to the invention according to a fifth embodiment ;

FIG. 6: a schematic sectional view of an underbody protection according to the invention according to a sixth embodiment;

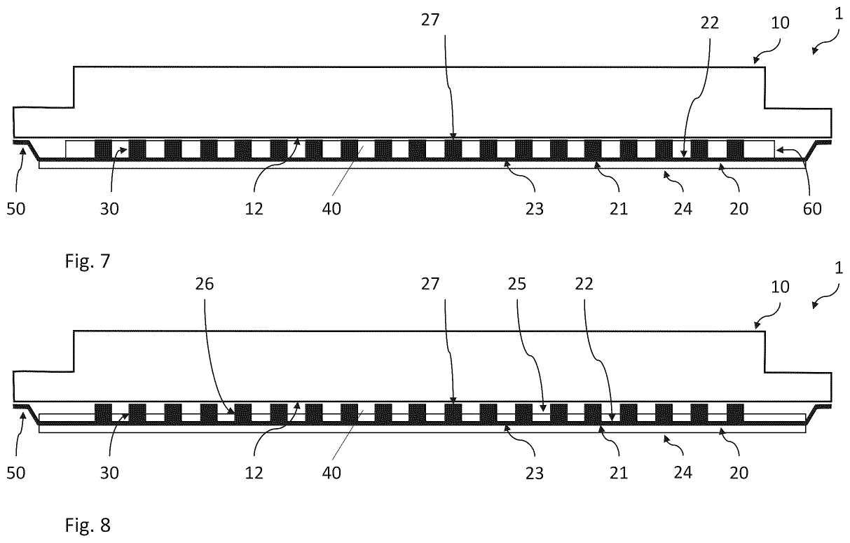

FIG. 7: a schematic sectional view of an underbody protection according to the invention according to a seventh embodiment;

FIG. 8: a schematic sectional view of an underbody protection according to the invention according to an eighth embodiment; and

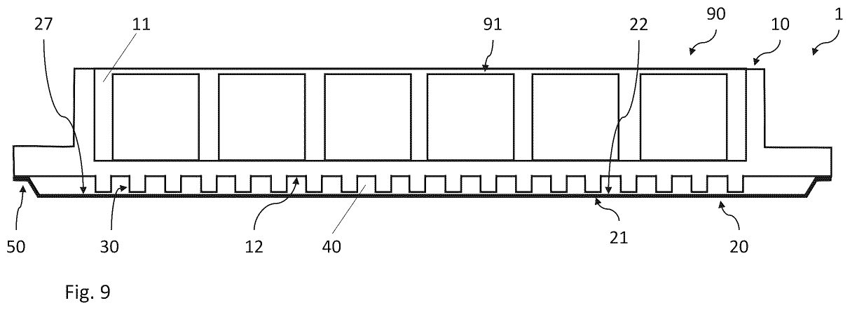

FIG. 9: a schematic sectional view of a traction battery according to the invention comprising an underbody protection according to a ninth embodiment.

In the following description, the same reference numerals denote the same components or the same features, so that a description carried out in relation to one figure with regard to a component also applies to the other figures, so that a repetitive description is avoided. Furthermore, individual features described in connection with one embodiment can also be used separately in other embodiments.

FIG. 1A shows a schematic sectional view of an underbody protection 1 for a motor vehicle according to a first embodiment of the present invention. The underbody protection 1 has at least one base component 10, at least one protective element 20 and at least two ribs 30. In the embodiment shown in FIG. 1A and also in the other embodiments shown in FIGS. 2 to 9, the underbody protection 1 has a plurality of ribs 30 (more than two ribs).

In the embodiment of the underbody protection 1 shown in FIG. 1A, the ribs 30 are formed monolithically with the base component 10. Furthermore, the ribs 30 are sandwiched between the protective element 20 and the base component 10, so that a plurality of cavities 40 are formed between the protective element 20 and an underside 12 of the base component 10, which are at least partially delimited by the ribs 30. Furthermore, the cavities 40 are delimited by the protective element 20.

In the embodiment of the underbody protection 1 shown in FIG. 1A, the protective element 20 is connected to the base component 10 by means of a plurality of screws 70. As can be seen in FIG. 1B, at least some of the screws 70 are each screwed into a rib 30.

If the protective element 20 is designed as a plastic element 20 or as an Organosheet 20 or has a plastic element 20 or an Organosheet 20, the protective element 20 can be connected to the base component 10 with a material bond. For this purpose, the base component 10 can also be made of plastic or at least the part of the base component 10 that is in contact with a connecting surface 27 of the protective element 20 can be made of plastic.

It can also be seen from FIG. 1A that the underbody protection 1 has a connecting flange 50 arranged at the edge. This closes an intermediate space between the protective element 20 and the base component 10 so that, for example, no water can penetrate into this intermediate space. Furthermore, the protective element 20 and the base component 10 are in contact with each other in the region of the connecting flange 50 and are preferably connected to each other in the region of the connecting flange 50. For example, the protective element 20 can be connected to the base component 10 in the area of the flange 50 with a material connection and/or by means of a plurality of screws.

FIG. 2 shows a schematic sectional view of an underbody protection 1 according to a second embodiment of the present invention. The underbody protection 1 according to the second embodiment is designed such that at least some of the cavities 40 are filled with a foam material 60. The protective element 20 can be connected to the base component 10 by means of the foam material 60. Furthermore, it is also possible that the protective element 20 is connected to the base component 10 by means of a plurality of screws not shown in FIG. 2. Furthermore, the protective element 20 can be connected to the base component 10 with a material bond.

The remaining structure of the underbody protection 1 shown in FIG. 2 corresponds to the structure shown in FIG. 1A, so that reference is made to the above explanations in order to avoid repetition.

FIG. 3 shows a schematic sectional view of an underbody protection 1 according to a third embodiment of the present invention. The underbody protection 1 shown in FIG. 3 differs from the underbody protection 1 shown in FIG. 1A in that the ribs 30 are not formed monolithically with the base component 10, but monolithically with the protective element 20. In the embodiment shown in FIG. 3, the connecting surfaces 27 of the protective element 20 are the end edges of the respective ribs 30, which are arranged opposite the underside 12 of the base component 10.

The remaining structure of the underbody protection 1 shown in FIG. 3 corresponds to that of the underbody protection 1 shown in FIG. 1, so that reference is made to the corresponding explanations above in order to avoid repetition.

FIG. 4 shows a schematic sectional view of an underbody protection 1 according to a fourth embodiment of the present invention. In the underbody protection 1 shown in FIG. 4, at least some of the cavities 40 are filled with a foam material 60. In the embodiment shown in FIG. 4, all of the cavities 40 are filled with the foam material 60.

The foam material 60 offers the possibility that the protective element 20 is connected to the base component 10 by means of the foam material 60. The further connection options of the protective element 20 to the base component 10, which are explained in more detail with reference to FIG. 3, are also possible in the embodiment shown in FIG. 4. Consequently, the protective element 20 can be connected to the base component 10 by means of a plurality of screws. Furthermore, the protective element 20 can be connected to the base component 10 by a material bond.

The remaining structure of the underbody protection 1 shown in FIG. 4 corresponds to the structure of the underbody protection 1 shown in FIG. 3, so that reference is made to the corresponding explanations above in order to avoid repetition.

FIG. 5 shows a schematic sectional view of an underbody protection 1 according to a fifth embodiment of the present invention. In the underbody protection 1 shown in FIG. 5, the protective element 20 has a plastic layer 23 and a protective layer 24, which is connected to the plastic layer 23. The protective layer 24 is arranged on an outer side 21 of the protective element 20 facing away from the ribs 30.

The plastic layer 23 may comprise thermoplastic plastic, preferably polypropylene or polyamide. Alternatively, the plastic layer 23 may comprise thermosetting plastic. The plastic layer 23 can be formed, at least in sections, as a fiber-reinforced plastic layer 24, wherein the fibers can be formed as glass fibers and/or carbon fibers and/or aramid fibers.

The protective layer 24 can, for example, be in the form of an Organosheet 24 or a metal layer 24.

The remaining structure of the underbody protection 1 shown in FIG. 5 corresponds to the structure of the underbody protection 1 shown in FIG. 3, so that reference is made to the corresponding explanations above in order to avoid repetition.

FIG. 6 shows a schematic sectional view of an underbody protection 1 according to a sixth embodiment of the present invention. In the underbody protection 1 shown in FIG. 6, the protective element 20 has a plastic layer 23 and a protective layer 25, which is connected to the plastic layer 23. The one protective layer 25 is arranged on an inner side 22 of the protective element 20 facing the ribs 30. The protective layer 25 arranged on the inner side 22 facing the ribs 30 has a plurality of through openings 26 through which the material of the plastic layer 23 forming the ribs 30 protrudes.

In the embodiment of the underbody protection 1 shown in FIG. 6, the plastic layer 23 can also comprise thermoplastic material, preferably polypropylene or polyamide. Alternatively, the plastic layer 23 may comprise thermosetting plastic. The plastic layer 23 can be formed at least in sections as a fiber-reinforced plastic layer 24, whereby the fibers can be formed as glass fibers and/or carbon fibers and/or aramid fibers.

The protective layer 24 can, for example, be in the form of an Organosheet 24 or a metal layer 24.

The remaining structure of the underbody protection 1 shown in FIG. 6 corresponds to the structure of the underbody protection 1 shown in FIG. 3, so that reference is made to the corresponding explanations above in order to avoid repetition.

FIG. 7 shows a schematic sectional view of an underbody protection 1 according to a seventh embodiment of the present invention. In the underbody protection 1 shown in FIG. 7, at least some of the cavities 40 are filled with a foam material 60, wherein in the embodiment shown in FIG. 7, all of the cavities 40 are filled with the foam material 60.

The foam material 60 offers the possibility that the protective element 20 is connected to the base component 10 by means of the foam material 60. The further connection options of the protective element 20 to the base component 10, which are explained in more detail with reference to FIG. 3, are also possible in the embodiment shown in FIG. 7. Consequently, the protective element 20 can be connected to the base component 10 by means of a plurality of screws. Furthermore, the protective element 20 can be connected to the base component 10 by a material bond.

The remaining structure of the underbody protection 1 shown in FIG. 7 corresponds to the structure of the underbody protection 1 shown in FIG. 5, so that reference is made to the corresponding explanations above in order to avoid repetition.

FIG. 8 shows a schematic sectional view of an underbody protection 1 according to an eighth embodiment of the present invention. In the underbody protection 1 shown in FIG. 8, the protective element 20 has a first protective layer 24, a second protective layer 25 and a plastic layer 23, each of which is connected to the two protective layers 24, 25.

The first protective layer 24 is arranged on the outer side 21 of the protective element 20 facing away from the ribs 30. The second protective layer 25 is arranged on the inside 22 of the protective element 20 facing the ribs 30. The second protective layer 25 has a plurality of through openings 26, through which the material of the plastic layer 23 forming the ribs 30 protrudes. The plastic layer 23 is arranged like a sandwich between the first protective layer 24 and the second protective layer 25.

In the embodiment of the underbody protection 1 shown in FIG. 8, the plastic layer 23 can also comprise thermoplastic material, preferably polypropylene or polyamide. Alternatively, the plastic layer 23 may comprise thermosetting plastic. The plastic layer 23 can be formed at least in sections as a fiber-reinforced plastic layer 24, whereby the fibers can be formed as glass fibers and/or carbon fibers and/or aramid fibers.

The first protective layer 24 can, for example, be in the form of an Organosheet 24 or a metal layer 24. The second protective layer 25 can, for example, be formed as an Organosheet 25 or as a metal layer 25.

The remaining structure of the underbody protection 1 shown in FIG. 8 corresponds to the structure of the underbody protection 1 shown in FIG. 6, so that reference is made to the corresponding explanations above in order to avoid repetition.

FIG. 9 shows a schematic sectional view of a battery housing 90 for a traction battery 80, comprising an underbody protection 1 according to a ninth embodiment, wherein a battery housing shell 10 of the battery housing 90 is formed as a base component 10 of the underbody protection 1.

The ribs 30 are formed monolithically with the base component 10. Furthermore, the underbody protection 1 has a connecting flange 50 arranged on the edge.

The base component 10 is shell-shaped and at least partially delimits a receiving volume 11. Consequently, in the embodiment shown in FIG. 9, the base component 10 is designed as a battery housing shell 10, which is designed to receive battery cells 91 and/or battery modules. In the illustrated embodiment, a plurality of battery cells 91 are arranged in the receiving volume 11.

Although not shown in FIG. 9, the underbody protection 1 can also be designed as shown in FIGS. 1 to 8, in which case the base component 10 is always shell-shaped and at least partially delimits a receiving volume 11, which is designed to receive battery cells 91 and/or battery modules.

### LIST OF REFERENCE NUMERALS

1 Underbody protection/battery housing shell
10 Base component/battery housing
11 Receiving volume (of the base component)
12 Underside (of the base component)
20 Protective element/metal plate/plastic element/Organosheet
21 Outside (of the protective element)
22 Inside (of the protective element)
23 Plastic layer/plastic coating/plastic sheet
24 (first) protective layer
25 (second) protective layer
26 Through opening (of the protective layer)
27 (first) connecting surface (of the protective element)
30 Rib
40 Cavity
50 Connecting flange
60 Foam material/foam layer/foam layer
70 Screw
80 Traction battery
90 Battery housing
91 Battery cell/battery module

1. Underbody protection for a motor vehicle, comprising:
at least one base component;
at least one protective element;
at least two ribs,
wherein
the at least two ribs are arranged in a sandwich-like manner between the protective element and the base component, a plurality of cavities are formed between the protective element and an underside of the base component, which are at least partially defined by the ribs; and
the protective element is connected to the base component.

2. The underbody protection according to claim 1, characterized in that the protective element has at least one plastic layer and at least one protective layer which is connected to the plastic layer.

3. The underbody protection according to claim 2, characterized in that the at least one protective layer is arranged on an outer side of the protective element facing away from the ribs.

4. The underbody protection according to claim 2, characterized in that the at least one protective layer is arranged on an inner side of the protective element facing the ribs.

5. The underbody protection according to claim 1, characterized by the following features:
the protective element has two protective layers and a plastic layer, which is connected to the two protective layers;
the plastic layer is sandwiched between a first protective layer (24), which is arranged on an outer side of the protective element facing away from the ribs, and a second protective layer, which is arranged on an inner side of the protective element facing the ribs.

6. The underbody protection according to claim 4, characterized in that the protective layer arranged on the inner side facing the ribs has a plurality of through openings through which the material of the plastic layer forming the ribs protrudes.

7. The underbody protection according to claim 1, characterized by the following features:
the protective element is connected to the base component by means of a plurality of screws; and
at least some of the screws are each screwed into a rib.

8. The underbody protection according to claim 1, characterized in that at least some of the ribs are formed monolithically with the base component.

9. The underbody protection according to claim 1, characterized in that at least some of the ribs are formed monolithically with the protective element.

10. The underbody protection according to claim 1, characterized in that the at least one protective element (20) comprises at least one metal plate and/or at least one plastic element and/or at least one organosheet.

11. The underbody protection according to claim 1, characterized in that the underbody protection has a connecting flange arranged at the edge.

12. The underbody protection according to claim 1, characterized in that a first connecting surface of the protective element is connected to the base component by a material bond.

13. The underbody protection according to claim 1, characterized in that at least some of the cavities are filled with a foam material.

14. The underbody protection according to claim 13, characterized in that the protective element is connected to the base component by means of the foam material.

15. The underbody protection according to claim 1, characterized in that the base component is shell-shaped and at least partially delimits a receiving volume which is designed to receive battery cells and/or battery modules.

16. Battery housing for a traction battery, comprising the underbody protection according to claim 1, wherein a battery housing shell of the battery housing is formed as a base component of the underbody protection.

17. The traction battery for a motor vehicle, comprising at least one battery cell and/or at least one battery module and a battery housing according to claim 16, wherein the at least one battery cell and/or the at least one battery module is/are arranged in the battery housing.

18. The motor vehicle comprising the underbody protection according to claim 1, which is attached to an underbody of the motor vehicle, in particular to a traction battery of the motor vehicle.
